(19) United States
(12) Patent Application Publication
(10) Pub. No.: US 2003/0098613 A1
(43) Pub. Date: May 29, 2003

(54) Method and automatic control system for actuating an eletronically controlled brake actuation system

(76) Inventors: J?uuml;rgen Böhm, (US); Thorsten Ullrich, Gernsheim (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/312,130

(22) PCT Filed: Jun. 15, 2001
(86) PCT No.: PCT/EP01/06732

(30) Foreign Application Priority Data
Jun. 20, 2000 (DE) 100 31 011.7
Feb. 13, 2001 (DE) 101 06 464.0

(51) Int. Cl. B60T 8/66

(52) U.S. Cl. 303/166

(57) ABSTRACT

The present invention relates to a method and a control system for actuating an electronically controllable brake actuation system for motor vehicles, including a non-pressurized pressure fluid supply reservoir (4), at least one pressure source (20) that can be actuated by an electronic control unit (32) and whose pressure can be applied to wheel brakes (7, 8, 9, 10) of the vehicle, with pressure control valves (inlet valve 17, 18; outlet valve 27, 28) that can be actuated in an analog manner by means of an electric quantity being associated with said wheel brakes and connecting the wheel brakes (7 to 10) optionally with the pressure source (20) or the pressure fluid supply reservoir (4).

In order to allow for an adaptation of the volume flows to be controlled to the respective volume requirement and to bring about the desired pressure variation speeds, the present invention suggests that on actuation of the pressure control valves (17, 18; 27, 28), the electric quantity be limited in dependence on the hydraulic differential pressure (Δp) applied to the said valve.

The present invention relates to a method and a control system for actuating an electronically controllable brake actuation system for motor vehicles, including a non-pressurized pressure fluid supply reservoir, at least one pressure source that can be actuated by an electronic control unit and whose pressure can be applied to wheel brakes of the vehicle, with pressure control valves that can be actuated in an analog manner by means of an electric quantity being associated with said wheel brakes and connecting the wheel brakes optionally with the pressure source or the pressure fluid supply reservoir.

EP 0 832 019 B1 e.g. discloses a brake actuation system of this type. The pressure control valves associated with the wheel brakes in the prior art brake actuation system are electromagnetically analogously actuatable valves arranged in pairs and configured as seat valves, with the inlet valves thereof interposed in the connection between the pressure source and the wheel brakes being designed as normally closed seat valves performing a pressure-limiting function in their closed switch position, while the outlet valves interposed in the connection between the wheel brakes and the pressure fluid supply reservoir are designed as normally open valves that open the connection in their open switch position and close it in their closed switch position.

The above-mentioned publication, however, does not disclose any measures that permit an adaptation of the volume flows being controlled to the respective volume requirement and bring about the desired pressure variation speeds.

It is, however, known in the art to achieve such adaptations by using mechanical apertures that are connected upstream of the mentioned valves. Yet the use of apertures of this type entails an increased complexity of construction in order to implement appropriate valve designs for the desired parameters.

In view of the above, an object of the present invention is to suggest a method for actuating an electronically controllable brake actuation system of the type mentioned hereinabove as well as a control system obviating the need for mechanical apertures.

In method terms, this object is achieved in that on actuation of the pressure control valve under review, the electrical quantity is limited in dependence on the hydraulic differential pressure applied to the said valve.

To render the idea of the present invention more specific, it is arranged for that the pressure control valves are configured as electromagnetically actuatable valves, and that the electric quantity is an electric current being supplied to the electromagnetic drive, or that the pressure control valves are configured as piezoelectrically actuatable valves, and that the electric quantity is an electric voltage being supplied to the piezoelectric drive.

It is especially favorable that for limiting the current being supplied to the pressure control valve under review, a volume flow family of characteristics Q=f(I, Δp=const.) is evaluated, or for limiting the voltage being applied to the pressure control valve under review a volume flow family of characteristics Q=f(U, Δp=const.) is evaluated describing the static actual performance of the pressure control valves.

A suitable improvement of the idea of the present invention includes the determination of a desired volume flow characteristic curve Q_{desire,max}=f(Δp;I=Iₗᵢₘᵢₜ(Δp)) to be adjusted by the current limitation or a desired volume flow characteristic curve Q_{desire,max}=f(Δp;U=Uₗᵢₘᵢₜ(Δp)) to be adjusted by the voltage limitation, respectively.

Finally, the selection of several differential pressure values (Δp_{1, 2, 3}) allows determining several volume flow values (Q_{1,2,3}) from the desired volume flow characteristic curve Q_{desire,max}=f(Δp;I=Iₗᵢₘᵢₜ(Δp)) or, respectively, volume flow characteristic curve Q_{desire,max}=f(Δp;I=Uₗᵢₘᵢₜ(Δp)) to be adjusted by the current limitation or the voltage limitation, respectively, said volume flow characteristic curve being used to determine several current limit values (I_{1,2,3}) from the first volume flow characteristic curve Q=f(I,Δp=const.) corresponding to the differential pressure values (Δp_{1,2,3}) or, respectively, to determine several voltage limit values (U_{1,2,3}) from the first volume flow characteristic curve Q=f(U,Δp=const.) corresponding to the differential pressure values (Δp_{1,2,3}), with said limit values being taken into account for the formation of the desired current limitation characteristics Iₗᵢₘᵢₜ=f(Δp) or, respectively, for the formation of the desired voltage limitation characteristics Uₗᵢₘᵢₜ=f(Δp).

A control system according to the present invention for implementing the method mentioned hereinabove is characterized in that a pressure controller is provided to which are sent, as input quantities, a nominal pressure value to be applied to one of the wheel brakes of the vehicle, an actual pressure value which is applied to one of the wheel brakes of the vehicle, as well as the hydraulic differential pressure applied to the pressure control valve under review, and whose output quantity is the nominal value of the electric quantity used for actuating the pressure control valve, with a limitation module being connected downstream of said pressure controller, to which limitation module the desired current limitation characteristics (Iₗᵢₘᵢₜ=f(Δp) or, respectively, the desired voltage limitation characteristics Uₗᵢₘᵢₜ=f(Δp) is sent as another input quantity, and the output quantity whereof is the nominal value of the electric quantity used for actuating the pressure control valve.

Connected upstream of the limitation module is, preferably, a correction module wherein the value of the desired limitation of the electric quantity (Iₗᵢₘᵢₜ=f(Δp) or Uₗᵢₘᵢₜ=f(Δp)), respectively, is associated with the hydraulic differential pressure value that is applied to the pressure control valve under review.

Further, it is especially advantageous that the pressure controller comprises a linear controller and a pilot control module, with the deviation that is produced from the nominal pressure value and the actual pressure value being sent as an input quantity to the linear controller, while a signal representative of the hydraulic differential pressure applied to the pressure control valves is sent to the pilot control module, with said pilot control module producing a value of the electric quantity used for actuating the pressure control valve, said value corresponding to the point of opening of the pressure control valves and being added to the output quantity of the linear controller for producing the nominal value of the electric quantity that is used for actuating the pressure control valve.

The present invention will be explained in detail in the following description of an embodiment by making reference to the accompanying drawings. In the drawings,

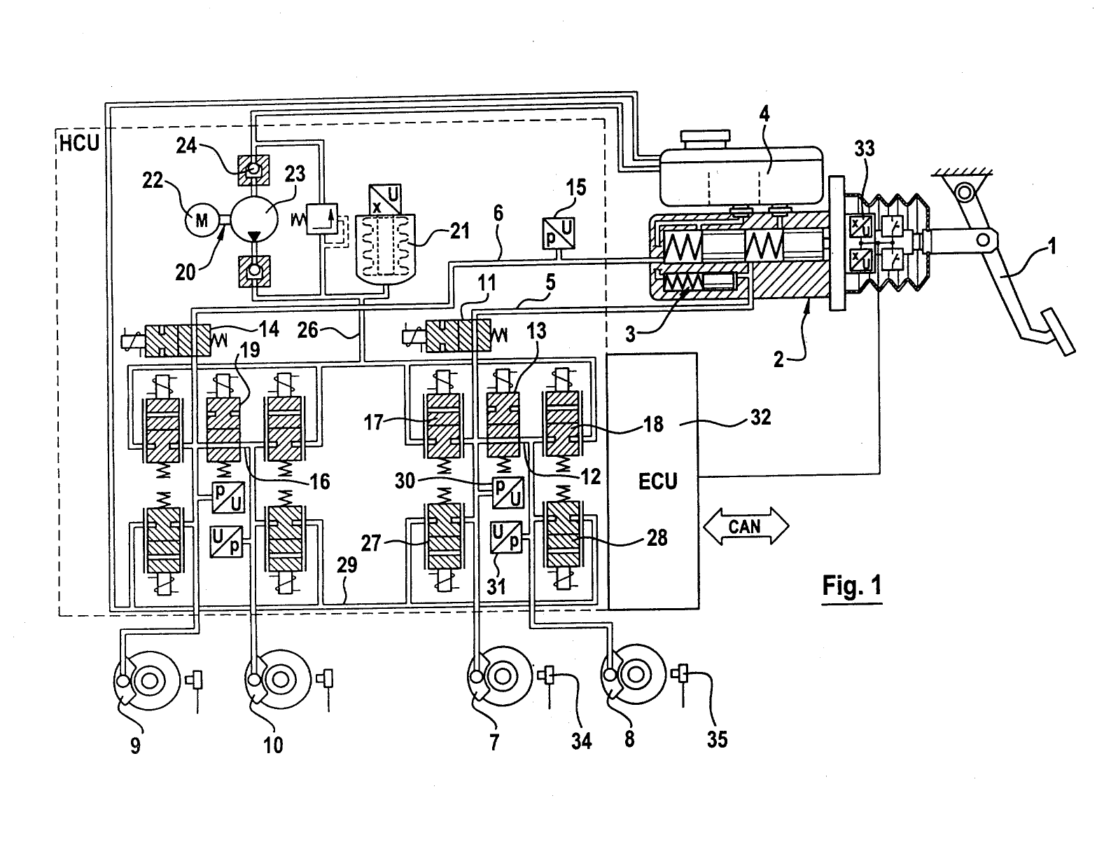

FIG. 1 is a simplified circuit diagram of a brake actuation system wherein the method of the invention can be implemented.

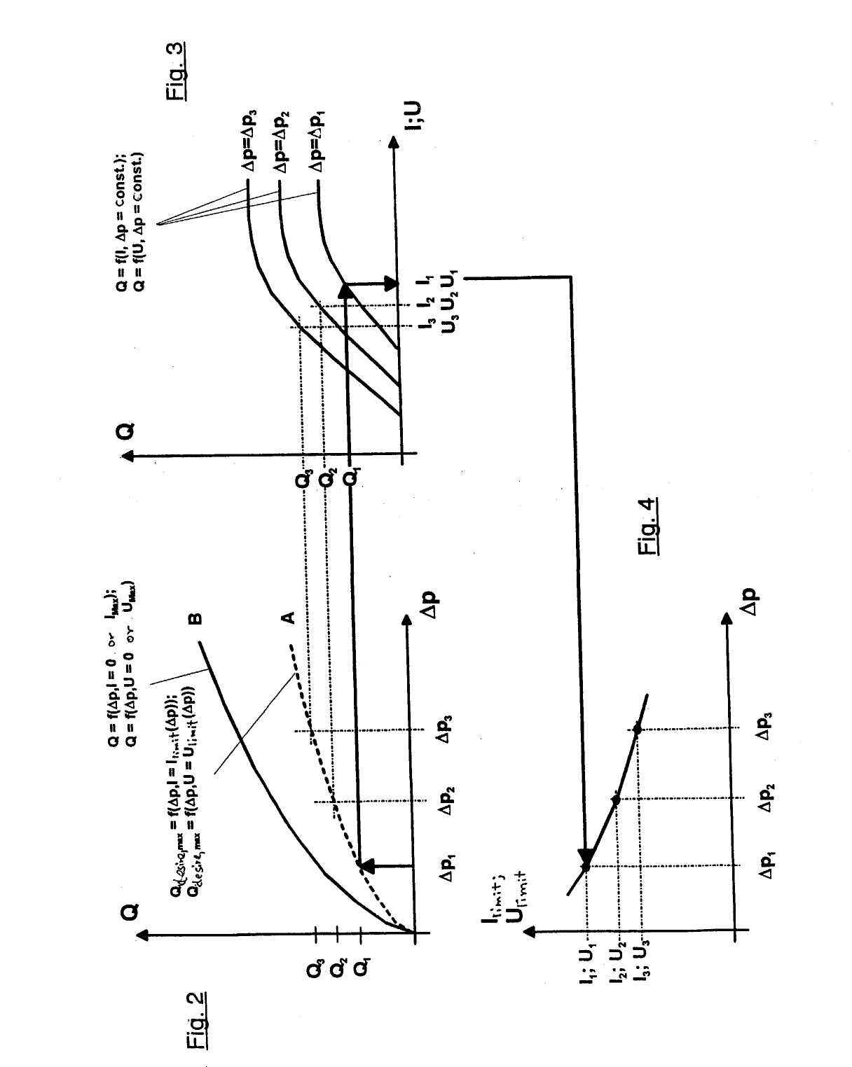

FIG. 2 is a graph of a first volume flow characteristic curve describing the performance of the pressure control valves.

FIG. 3 is a graph of a second volume flow characteristic curve describing the performance of the pressure control valves.

FIG. 4 is a graph showing the desired limitation characteristics.

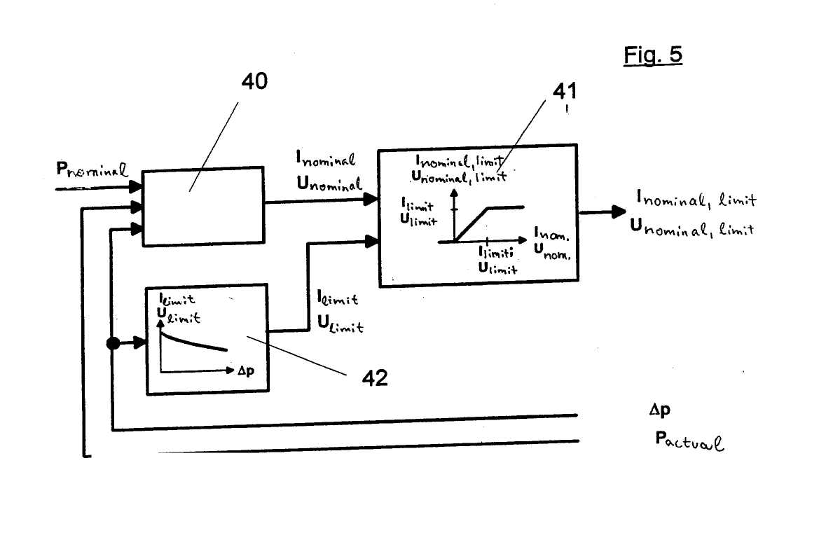

FIG. 5 shows the design of a control circuit for implementing the method of the invention.

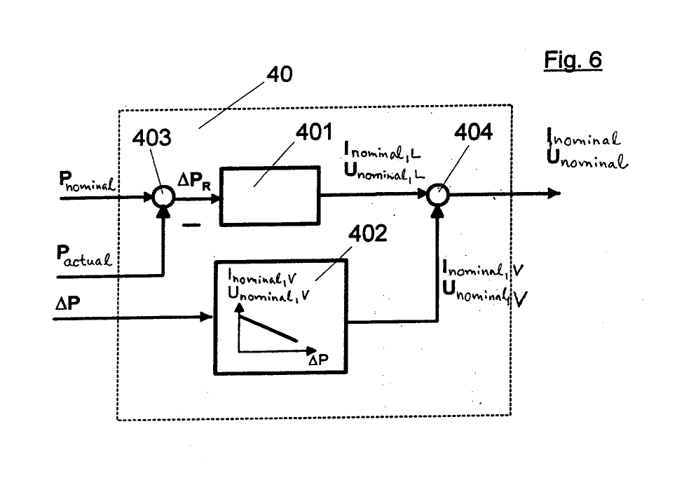

FIG. 6 shows the design of the pressure controller used in the control circuit according to FIG. 5.

The electronically controllable brake actuation system illustrated in FIG. 1 comprises a dual-circuit master brake cylinder or tandem master cylinder 2 that is operable by means of an actuating pedal 1, cooperates with a pedal travel simulator 3 and includes two pressure chambers isolated from one another and being in communication with a non-pressurized pressure fluid supply reservoir 4. Wheel brakes 7, 8 e.g. associated with the front axle are connected to the first pressure chamber (primary pressure chamber) by means of a closable first hydraulic line 5. Line 5 is closed by means of a first separating valve 11, while in a line portion 12 between the wheel brakes 7, 8 an electromagnetically operable, preferably normally open (NO) pressure-compensating valve 13 is inserted which enables brake pressure control on each individual wheel, if required.

The second pressure chamber of the master brake cylinder 2, to which a pressure sensor 15 may be connected, is connectable to the other pair of wheel brakes 9, 10 associated with the rear axle by way of a second hydraulic line 6 closable by means of a second separating valve 14. Again, an electromagnetically operable, preferably normally open (NO) pressure-compensating valve 19 is inserted into a line portion 16 disposed between the wheel brakes 9, 10. Because the design of the hydraulic circuit connected to the second pressure chamber of the master brake cylinder 2 is identical with the brake circuit 11 that is explained in the preceding description, it need not be discussed in the following text.

As can further be taken from the drawings, a motor-and-pump assembly 20 including a high-pressure accumulator 21 is provided as an independent pressure source, said assembly comprising in turn a pump 23 driven by means of an electric motor 22 as well as a pressure limiting valve 24 connected in parallel to said pump 23. The suction side of the pump 23 is connected to the above-mentioned pressure fluid supply reservoir 4 by way of a non-return valve 24. A pressure sensor (not shown) can monitor the hydraulic pressure generated by the pump 23.

A third hydraulic line 26 connects the high-pressure accumulator 21 to the inlet ports of two electromagnetic, normally closed two-way/two-position directional control valves 17, 18 of analog operation which are connected upstream of the wheel brakes 7 and 8 as inlet valves. Further, the wheel brakes 7, 8 are connected to a fourth hydraulic line 29 by way of each one electromagnetic, normally closed two-way/two-position directional control valve or outlet valve 27, 28 of analog operation, said line 29 being in communication with the non-pressurized pressure fluid supply reservoir 4, on the other hand. The hydraulic pressure prevailing in the wheel brakes 7, 8 is determined by means of each one pressure sensor 30, 31.

An electronic control unit 32 is used for the joint actuation of the motor-and-pump assembly 20 as well as the electromagnetic valves 11, 13, 14, 17, 18, 19, 27, 28, with the output signals of an actuating travel sensor 33 cooperating with the actuating pedal 1 and of the above-mentioned pressure sensor 15 being sent as input signals to said control unit 32, thereby permitting a detection of the driver's deceleration demand. However, other means such as a force sensor sensing the actuating force at the actuating pedal 1 may also be used for the detection of the driver's deceleration demand. As further input quantities, the output signals of the pressure sensors 30, 31 as well as the output signals of wheel sensors (only represented) representative of the speed of the vehicle are sent to the electronic control unit 32, with the wheel sensors associated with the wheel brakes 7, 8 being assigned reference numerals 34, 35.

The method of the present invention is used for the quasi-continuous, sensitively controllable pressure adjustment in the wheel brakes 7, 8 by means of the above-mentioned inlet valves 17, 18 and outlet valves 27, 28, and the implementation of said method is explained in the following text in connection to FIGS. 2 to 4. It must be taken into consideration that the method shall be used only on those pressure control valves where it is necessary to adapt the volume flow characteristic curve on account of the constructively predefined brake characteristic curve and the desired brake force proportioning. It is assumed that, as described above, all pressure control valves 17, 18, 27, 28 are configured as normally closed two-way/two-position directional control valves which are analogously controllable by means of an electromagnetic drive. Accordingly, the performance of the valves is influenced by variations of the electric current to be supplied to the electromagnetic drive, said current being limited, according to the idea of the invention, in dependence on the hydraulic differential pressure Δp prevailing at the inlet valve 17, 18 or outlet valve 27, 28, respectively, as defined in the following text:

For each pressure control valve at issue, initially a desired volume flow characteristic curve A that is to be adjusted by the current limitation is determined, said curve being shown in dotted lines in FIG. 2 and described by the equation Q_{desire, max}=f(Δp;I=Iₗᵢₘᵢₜ(Δp)). Q_{desire, max} refers to the desired volume flow maximally to be adjusted, while Iₗᵢₘᵢₜ(Δp) designates the maximum, limited current value. This characteristic curve which is stored in the above-mentioned electronic control unit 32 lies below a volume flow characteristic curve B which corresponds to a non-adapted valve and is described by the equation Q=f(Δp;I=I_{Max}). FIG. 3 illustrates a volume flow family of characteristics with the differential pressure Δp as a parameter that is also stored in the electronic control unit 32 and illustrates the actual performance of the pressure control valve. The individual volume flow characteristic curves follow the functional correlation Q=f(I, Δp=const.), wherein Q designates the actual volume flow which flows through the pressure control valve on actuation of the electromagnetic drive by means of current I. If, for example, three different differential pressure values Δp₁, Δp₂, Δp₃ (FIG. 2) are selected from the desired volume flow characteristic curve Q_{desire,max}=f(Δp;I=Iₗᵢₘᵢₜ(Δp)), with which desired volume flows Q₁, Q₂, Q₃ correspond, it is possible to read current values I₁, I₂, I₃ from the family of characteristics according to FIG. 3 which correspond to the respectively chosen differential pressure value Δp₁, Δp₂, Δp₃. When now the current values I₁, I₂, I₃ being determined this way are plotted above the differential pressure values Δp₁, Δp₂, Δp₃, the desired current limitation characteristics Iₗᵢₘᵢₜ=f(Δp) is obtained which is shown in FIG. 4.

The above procedure was described in connection with pressure control valves that are actuated by means of an electromagnetic drive operable by electric current and also comprise normally open valves. However, the method concerned may of course be applied similarly to pressure control valves being actuated by means of a piezoelectric drive. In this case, the quantity influencing the actual performance of the piezoelectric valves is the voltage to be applied to the piezoelectric drive.

In FIGS. 5 and 6, finally, a control system for implementing the method of the invention is shown. The illustrated control system, which is a component of the above-mentioned electronic control unit 32, essentially comprises a pressure controller 40, a limitation module 41 connected downstream of the pressure controller 40, as well as a correction module 42, the output quantity of which serves to influence the function of the limitation module 41. As input quantities, signals are sent to the pressure controller 40 which are representative of the nominal pressure value Pₙₒₘᵢₙₐₗ that shall be applied to one of the wheel brakes 7 to 10, the actual pressure value P_{actual} that is applied to one of the wheel brakes 7 to 10, as well as the differential pressure Δp prevailing at the corresponding pressure control valve. The output quantity of the pressure controller 40 represents the nominal value Iₙₒₘᵢₙₐₗ or, respectively, Uₙₒₘᵢₙₐₗ of the electric current to be supplied to the electromagnetically operable pressure control valve, or, respectively, the voltage to be applied to the piezoelectrically operable pressure control valve. In the correction module 42, current or voltage values Iₗᵢₘᵢₜ or Uₗᵢₘᵢₜ, respectively, are associated with different differential pressure values Δp, the said limit values along with the output quantity Iₙₒₘᵢₙₐₗ or Uₙₒₘᵢₙₐₗ, respectively, of the pressure controller 40 being sent to the limitation module 41 in which the desired limitation of Iₙₒₘᵢₙₐₗ or Uₙₒₘᵢₙₐₗ, respectively, that is responsive to differential pressure takes place. The output quantity of the limitation module 41 represents the limited nominal value I_{nominal,limit} or U_{nominal,limit}, respectively, of the electric current to be supplied to the electromagnetically operable pressure control valve or, respectively, the voltage to be applied to the piezoelectrically operable pressure control valve.

As can be taken from FIG. 6 in particular, the above-mentioned pressure controller 40 is mainly formed of a linear controller 401 and a pilot control module that is designated by reference numeral 402. As an input quantity of the linear controller 401 a deviation ΔP_{R} is used which is produced from the nominal pressure value Pₙₒₘᵢₙₐₗ and the actual pressure value P_{actual} in a subtractor 403 connected upstream of the controller 401, while the output quantity I_{nominal,V} or U_{nominal,V}, respectively, of the pilot control module 402 is added in a counting stage 404 to the output quantity I_{nominal,L} or U_{nominal,L}, respectively, of the linear controller 401.

1. Method for actuating an electronically controllable brake actuation system for motor vehicles, including a non-pressurized pressure fluid supply reservoir (4), at least one pressure source (20) that can be actuated by an electronic control unit (32) and whose pressure can be applied to wheel brakes (7, 8, 9, 10) of the vehicle, with pressure control valves (inlet valve 17, 18; outlet valve 27, 28) that can be actuated in an analog manner by means of an electric quantity being associated with said wheel brakes and connecting the wheel brakes (7 to 10) optionally with the pressure source (20) or the pressure fluid supply reservoir (4),
characterized in that on actuation of the pressure control valve (17, 18; 27, 28) under review, the electric quantity is limited in dependence on the hydraulic differential pressure (Δp) applied to the said valve.

2. Method for actuating an electronically controllable brake actuation system as claimed in claim 1,
characterized in that the pressure control valves (17,18;27,28) are configured as electromagnetically actuatable valves, and that the electric quantity is an electric current being supplied to the electromagnetic drive.

3. Method for actuating an electronically controllable brake actuation system as claimed in claim 1,
characterized in that the pressure control valves are configured as piezoelectrically actuatable valves, and that the electric quantity is an electric voltage being supplied to the piezoelectric drive.

4. Method for actuating an electronically controllable brake actuation system as claimed in claim 2,
characterized in that for limiting the current being supplied to the pressure control valve (17, 18; 27, 28) under review, a volume flow family of characteristics Q=f(I, Δp=const.) is evaluated which describes the static actual performance of the pressure control valve (17, 18; 27, 28).

5. Method for actuating an electronically controllable brake actuation system as claimed in claim 4,
characterized in that a desired volume flow characteristic curve Q_{desire, max}=f(Δp;I=Iₗᵢₘᵢₜ(Δp)) (A) is determined which is to be adjusted by the current limitation.

6. Method for actuating an electronically controllable brake actuation system as claimed in claims 4 and 5,
characterized in that the selection of several differential pressure values (Δp_{1,2,3}) allows determining several volume flow values (Q_{1,2,3}) from the desired volume flow characteristic curve Q_{desire,max}=f(Δp;I =Iₗᵢₘᵢₜ(Δp)) (A), said curve being used to determine several current limit values (I_{1,2,3}) from the first volume flow characteristic curve Q=f(I,ΔP=const.) corresponding to the differential pressure values (Δp_{1,2,3}), said current limit values being taken into account for the formation of the desired current limitation characteristics Iₗᵢₘᵢₜ=f(Δp).

7. Method for actuating an electronically controllable brake actuation system as claimed in claim 3,
characterized in that for limiting the voltage to be applied to the pressure control valve under review, a volume flow family of characteristics Q=f(U, Δp=const.) is evaluated which describes the static actual performance of the pressure control valve.

8. Method for actuating an electronically controllable brake actuation system as claimed in claim 7,
characterized in that a desired volume flow characteristic curve Q_{desire,max}=f(Δp;I=Uₗᵢₘᵢₜ(Δp)) (A) is determined which is to be adjusted by the voltage limitation.

9. Method for actuating an electronically controllable brake actuation system as claimed in claim 7 and 8,
characterized in that the selection of several differential pressure values (Δp_{1,2,3}) allows determining several volume flow values (Q_{1,2,3}) from the desired volume flow characteristic curve Q_{desire,max}=f(Δp;U =Uₗᵢₘᵢₜ(Δp)) (A), said curve being used to determine several voltage limit values (U_{1,2,3}) from the volume flow family of characteristics Q=f(U,ΔP=const.) corresponding to the differential pressure values (Δp_{1,2,3}), said voltage limit values being taken into account for the formation of the desired voltage limitation characteristics Uₗᵢₘᵢₜ=f(Δp).

10. Control system for actuating an electronically controllable brake actuation system as claimed in any one of the preceding claims,
characterized in that a pressure controller (40) is provided to which are sent, as input quantities, a nominal pressure value (Pₙₒₘᵢₙₐₗ) to be applied to one of the wheel brakes (7, 8, 9, 10) of the vehicle, an actual pressure value (P_{actual}) which is applied to one of the wheel brakes (7, 8, 9, 10) of the vehicle, as well as the hydraulic differential pressure value (Δp) applied to the pressure control valve (17, 18; 27, 28) under review, and whose output quantity is the nominal value (Iₙₒₘᵢₙₐₗ or Uₙₒₘᵢₙₐₗ, respectively) of the electric quantity used for actuating the pressure control valve (17, 18; 27, 28), with a limitation module (41) being connected downstream of said pressure controller, to which limitation module is sent the value of the desired limitation of the electric quantity (Iₗᵢₘᵢₜ=f(Δp) or, respectively, Uₗᵢₘᵢₜ=f(Δp) used for the actuation of the pressure control valve (17, 18; 27, 28) as another input quantity, and the output quantity whereof is the nominal value (I_{nominal,limit} or U_{nominal,limit}, respectively) of the electric quantity (I, U) used for actuating the pressure control valve (17, 18; 27, 28).

11. Control system for actuating an electronically controllable brake actuation system as claimed in claim 10,
characterized in that connected upstream of the limitation module (41) is a correction module (42) in which the value of the desired limitation of the electric quantity Iₗᵢₘᵢₜ=f(Δp) or Uₗᵢₘᵢₜ=f(Δp), respectively, is associated with the hydraulic differential pressure value (Δp) that is applied to the pressure control valve (17, 18; 27, 28) under review.

12. Control system for actuating an electronically controllable brake actuation system as claimed in claim 10 or 11,
characterized in that the pressure controller (40) comprises a linear controller (401) and a pilot control module (402), with the deviation (ΔP_{R}) being produced from the nominal pressure value (Pₙₒₘᵢₙₐₗ) and the actual pressure value (P_{actual}) being sent as an input quantity to the linear controller (401), while a signal representative of the hydraulic differential pressure (Δp) applied to the pressure control valve (17, 18; 27, 28) under review is sent to the pilot control module (402), with said pilot control module (402) producing a value (I_{nominal,L}; U_{nominal,L}) of the electric quantity (I, U) used for actuating the pressure control valve (17, 18; 27, 28), said value corresponding to the point of opening of the pressure control valve (17, 18; 27, 28) and being added to the output quantity (I_{nominal,V}; U_{nominal,V}) of the linear controller (401) for producing the nominal value (Iₙₒₘᵢₙₐₗ, Uₙₒₘᵢₙₐₗ) of the electric quantity used for actuating the pressure control valve (17, 18; 27, 28).
